(19) United States
(12) Patent Application Publication
(10) Pub. No.: US 2013/0061527 A1
(43) Pub. Date: Mar. 14, 2013

(54) Double sliding security door

(71) Applicants: Michael Charles McNulty, Oakdale, CA (US); Betty J. McNulty, Oakdale, CA (US); Matthew J. McNulty, Oakdale, CA (US)

(72) Inventors: Michael Charles McNulty, Oakdale, CA (US); Betty J. McNulty, Oakdale, CA (US); Matthew J. McNulty, Oakdale, CA (US)

(21) Appl. No.: 13/199,793

(22) Filed: Sep. 9, 2011

(51) Int. Cl. E06B 3/46; E05C 7/04

(52) U.S. Cl. 49/367; 49/506

(57) ABSTRACT

A double sliding security door for the complete protection of both glass panels of a sliding glass door and preventing of unwanted people or things from entering a home. The double sliding security door generally includes 4 inner locking frame assembly parts, a center post attached to the top and bottom tracks, and 2 sliding doors with security screen, locks and bearing.

### BACKGROUND OF THE INVENTION

The present invention relates generally to sliding security doors and more specifically it relates to a double sliding security door for the complete protection of both glass panels of a sliding glass door and preventing of unwanted people or things from entering a home.

### BRIEF SUMMARY OF THE INVENTION

The invention generally relates to a sliding security door which includes 4 inner locking frame assembly parts, a center post attached to the top and bottom tracks, and 2 sliding doors with security screen, locks and bearing.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a double sliding security door for the complete protection of both glass panels of a sliding glass door and preventing of unwanted people or things from entering a home.

Another object is to provide a Double Sliding Security Door that will protect the glass of a patio door.

Another object is to provide a Double Sliding Security Door that will safely allow fresh air flow in to the home when the glass door in left open.

Another object is to provide a Double Sliding Security Door that will keep unwanted people and bugs out of the home when the glass door is open.

Another object is to provide a Double Sliding Security Door that is in a Kit form that is both easy to ship and is easy to install for a person that is handy with basic hand tools.

Another object is to provide a Double Sliding Security Door that easy to use and allows for easy cleaning of all the glass areas.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: FIG. 1 is a front view of the present invention. This the front view showing the main parts.

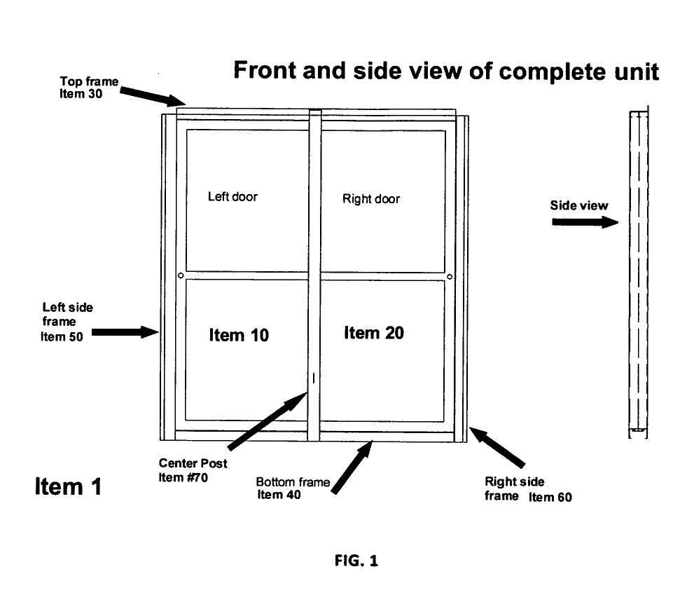

FIG. 2: FIG. 2 is a front view of the present invention. This is the front view of a sliding door that can be a Rt or a Lf. Not showing the security screening.

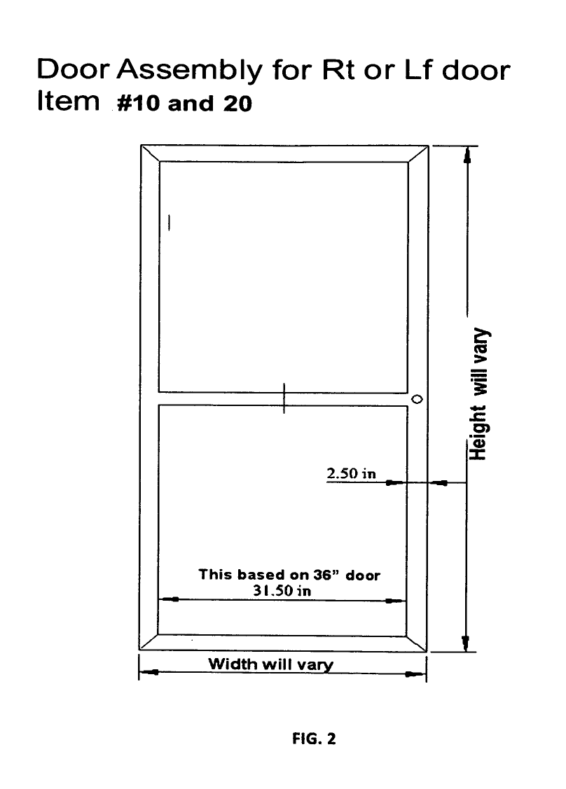

FIG. 3: FIG. 3 is an exploded side view of the present invention. Main parts of the top track assembly.

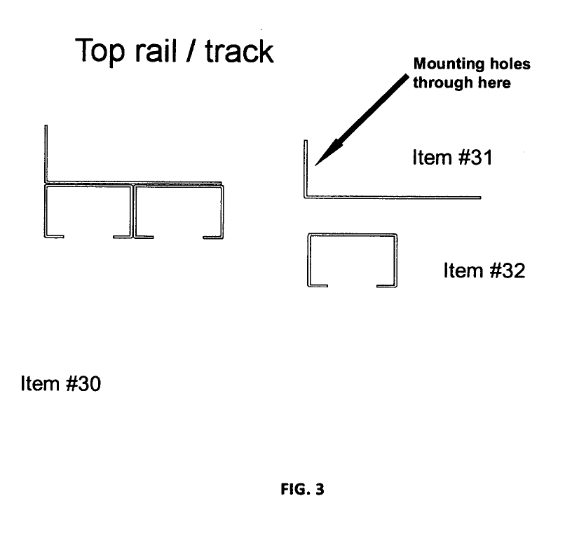

FIG. 4: FIG. 4 is an exploded side view of the present invention. The bottom track of the main frame assembly.

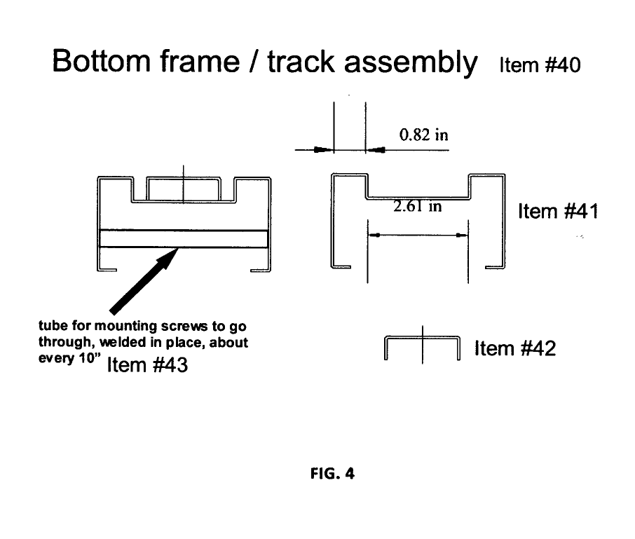

FIG. 5: FIG. 5 is an exploded side view of the present invention. Left side frame assembly of the main frame.

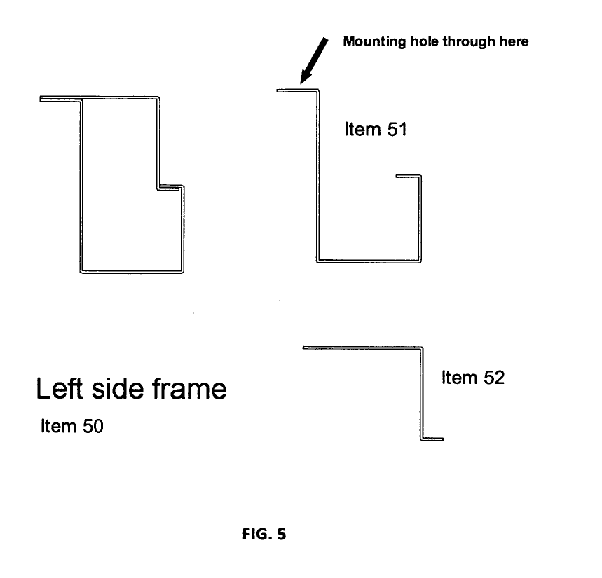

FIG. 6: FIG. 6 is an exploded side view of the present invention. This is the Left assembly of the main frame.

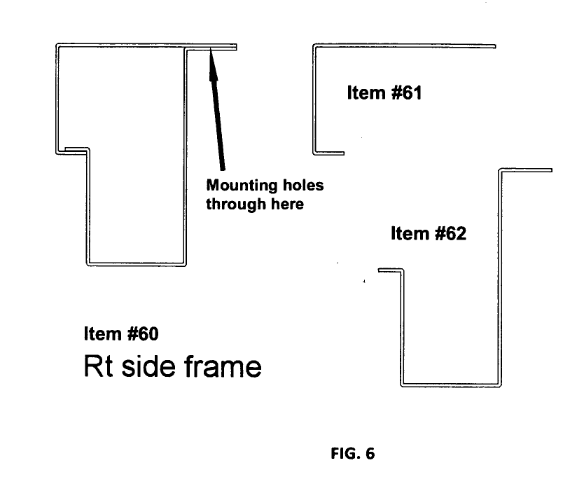

FIG. 7: FIG. 7 is an end view of the present invention. This center post is connected to the top and bottom track only.

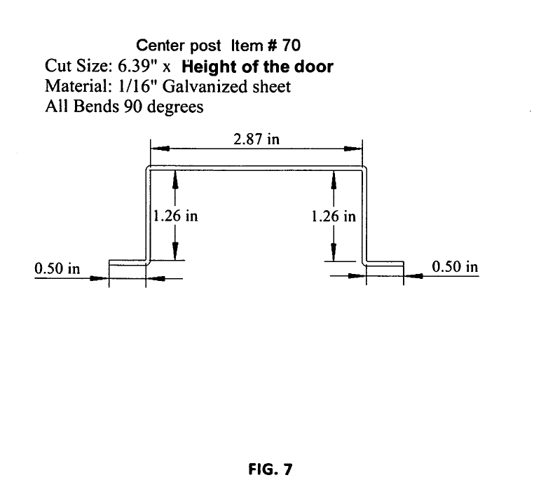

### DETAILED DESCRIPTION OF THE INVENTION

### A. Overview

Turning now descriptively to the drawings, in which similar reference characters denote similar elements throughout the several views, the figures illustrate 4 inner locking frame assembly parts, a center post attached to the top and bottom tracks, and 2 sliding doors with security screen, locks and bearing.

### B. Sliding Doors #10 And 20

The sliding doors gives security to the moving and non-moving glass area of the patio door. It has a trolley type top that hold the bearing and fits into the top track #30. The trolley design is such that no one can cut it off and remove the door. Each door fits into only one of the 2 tracts on top and on the bottom. The bottom of the door has a guide blade that fits into the narrow track on the bottom. Each door has a hook lock that fits into the side frame of item #50 and #60. The Height and width of each door will change based on the size of the glass patio door.

The sliding doors work from both side in a horizontal direction, giving protection to the glass door and the non-moving glass area. The doors move with ease yet have no more that, 125″ vertical movement. Adding the hook lock that also prevents the vertical or horizontal direction. The hook lock and the bottom track prevents the doors from being pried out.

### C. Top Track #30

This is a double track to guide both doors, keeping them separate and in line for the lock points. The trolley type top of the doors fit into each track with the 4 sealed bearings to support the weight of the doors. The height of each track is set by the bearings allowing for, 120″ max. In vertical movement. The length of the item will change based on the width of the patio glass door. The top track hold the trolley , bearings and keeps the doors lined up for proper operation.

### D. Bottom Frame And Track #40

The bottom frame track #40 holds the guide track that the sliding door fits into. The track is needed to prevent the doors from being pried out, it also keeps the doors in line to match the receiver opening for the hook locks in the side frame #50 and 60.

The bottom track keeps the two doors lined up and keep the doors from pried out.

### E. Right And Left Side Frames #50 And 60

These are the side members of the frame that hold the top and bottom tracks at the right distance apart. They also receive the hook part of the hook locks. The two side hold the top and bottom at the right distance from each other, receives the hook lock and is the stop post for the door.

### F. Center Post #70

The center post frame #70 is used to secure the top frame #30 and the bottom track frame #40 together keeping them at the correct vertical distance. Also it is a barrier preventing the doors from being pried out. The center post hold the top and bottom tracks at the correct height and keeps the doors from being pried out past it.

### G. Connections of Main Elements and Sub-Elements of Invention

All element are either welded or screwed together. Yet they are designed to be put together at the customers home with standard hand tools and in about 1 to 2 hours. This design allows for the unit to be shipped to a customers home.

The proper operation and security of this unit is dependent on the unique manufactured design that acts in harmony with each other member and the house to prevent twisting, prying or distortion of adjacent members of the assembly. If attempted forcible entry is applied to one member, the complete assembly as a unit utilizes the structural strength of the security material and the enter locking of each member. If enough force is applied to one or more areas or members so as to exceed its strength, bending will occur and causing one or more members to distort. This distorting will cause one or both doors to jam and keep them from opening. That in turn will prevent access to the vulnerable sliding glass doors area.

### H. Alternative Embodiments of Invention

There are no alternative variations at this time.

### I. Operation of Preferred Embodiment

Our sliding security door unit is unlike any other product in that it will completely cover both glass panels of a patio door. This should be made of metal or any other high security material. The unit is designed to be mounted on the outside of a building over a normal door way such as a sliding patio glass door. But it not limited to the sliding glass patio door, other locations that it would fit is where out swinging doors for security is not an option.

The proper operation and security of this unit is dependent on the unique manufactured design that acts in harmony with each other member and the house to prevent twisting, prying or distortion of adjacent members of the assembly. If attempted forcible entry is applied to one member, the complete assembly as a unit utilizes the structural strength of the security material and the enter locking of each member. If enough force is applied to one or more areas or members so as to exceed its strength, bending will occur and causing one or more members to distort. This distorting will cause one or both doors to jam and keep them from opening. That in turn will prevent access to the vulnerable sliding glass doors area. The unit is such to allow the unit to be ship able, and can be installed by 2 people with normal tools and average skills. It is made to have both doors lock using hook locks.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### INDEX OF ELEMENTS

10: Sliding Doors #10 And 20

11: Hook Lock (not Shown)

12: Top Trolley (not Shown)

13: Security Screen (not Shown)

20: Top Track #30

21: Mounting Plate #31 for Mounting Plate for #32 And Screws To The Wall

22: Track, Takes 2

30: Bottom Frame And Track #40

31: Frame #41 Is Formed To Hold The Track in Place

32: Item #42 Is The Center Plate That Forms The Two Tracks

33: Item #3 Is A Round Tube for Support of The Screws for Mounting

40: Right And Left Side Frames #50 And 60

41: Items #51 (#61) Is Formed To Make Part of A Side Frame

42: Item #52 (#62) Is Formed To Make The Other Part of The Side Frame

43: Mounting Holes Are Punched in It for Mounting (not Shown)

50: Center Post #70

51: Item #70 Is A Formed Long Item So As To Screw Into The Top And Bottom Track.

1. A security door comprising:
top and bottom track frames;
a plurality of side post frames engaged with said top and bottom track frames
a plurality of sliding doors positioned between said top and bottom track frames
a center post frame engaged with said top and bottom track frames
wherein said sliding doors, each has a lock attached to side post frame

2. The security door of claim 1 further comprising a plurality of alignment slip in joints on each frame member, for attaching frame members to the others.

3. A security door of claim 1 wherein said sliding doors comprises:
A ball bearing trolley engaged with said top track frame; and
a guide blade aligned with said bottom track frame.

4. A security door of claim 1 comprising a plurality of frame members having adapted areas for the mounting to a building

5. A method of utilizing a security door, said method comprising the steps of:
providing top and bottom track frames;
providing and engaging a plurality of side post frames with said top and bottom track frames, and said sliding doors, each having a lock attached to side post frames:
providing and engaging a center post with said top and bottom track frames;
A security door of claim 1 comprising of said members to be in a kit form for easy of shipping and installation
